(19) United States
(12) Patent Application Publication
(10) Pub. No.: US 2004/0139028 A1
(43) Pub. Date: Jul. 15, 2004

(54) System, process and article for conducting authenticated transactions

(76) Inventors: Jayme Matthew Fishman, North Reading, MA (US); Patrick Heinrich Rigney, Berkeley, CA (US)

Correspondence Address: PERKINS, SMITH & COHEN LLP, ONE BEACON STREET, 30TH FLOOR, BOSTON, MA, 02108, US

(21) Appl. No.: 10/723,657

(22) Filed: Nov. 26, 2003

Related U.S. Application Data
(63) Continuation-in-part of application No. 10/132,438, filed on Apr. 25, 2002.
(63) Continuation-in-part of application No. 09/816,975, filed on Mar. 23, 2001.

(51) Int. Cl. H04L 9/00; G06F 17/60

(52) U.S. Cl. 705/67; 713/172

(57) ABSTRACT

A system, process and articles for authentication of a party in transaction using authentication information embedded in a physical medium in the possession of the party plus a password or other personal code of party that are compared against corresponding information in a data base by an authentication server through comparison of one-use tokens generated in parallel from said embedded and personal codes.

### CROSS-REFERENCE TO RELATED APPLICATIONS

This application is a continuation-in-part of, and claims priority for subject matter disclosed in, the application by the one of the inventors in Ser. No. 10/132,438, filed Apr. 25, 2002, a continuation-in-part of Ser. No. 09/816,975, filed Mar. 22, 2001, by said inventor, both entitled “System and Process for Conducting Authenticated Transactions Online” and co-pending herewith.

### FIELD OF THE INVENTION

The invention relates generally to transactions conducted over a communications network that require authentication of a party to the transaction.

### BACKGROUND

There is need in an open communication network such as the Internet to provide authentication of transaction parties for a variety of reasons, including, without limitation, assurance of authorization to access certain information, the establishment of a legal contract between the parties, and assurance of creditworthiness of one of the parties. Systems implemented and proposed to provide authentication with various levels of confidence have focused on payment mechanisms.

In part because financial institution regulations in the United States have afforded some limitation of consumer liability for fraudulent use of credit cards, secure payment systems employing devices such as “smart cards” with embedded microprocessors, that require special readers (and writers), have not enjoyed popularity in the United States. One alternative proposed, for example by NYCE, is the use of a truncated CD (compact disk) cards, cut roughly to the shape and size of a credit card to allow use in conventional desktop and mobile computers and transportation in a wallet. Information used to generate “one-use” tokens of alphanumeric strings were proposed to be written on these CD cards, read on a consumer's desktop or mobile computer and transmitted to the issuer of the token for authentication of the token. The proposed NYCE system focuses on the authorization of the transaction rather than the identity of the holder of the CD card. While this may be adequate for payment systems analogous to the carrying of cash, there are many network transactions that require identification of a party to the transaction to determine authority, age, etc.

One-use tokens embedded in storage media are eventually exhausted through use. Upon such exhaustion, media must be brought to a secure facility for writing of new tokens or new media with tokens delivered, as downloading creates an opportunity for compromise of security.

Generally identification of a party to a transaction has been performed using passwords or personal identification numbers (“PINs”) bound to a user name. These pieces of information are susceptible to diversion. In transactions that require high levels of security, such as administration of a certification authority in a digital signature system, smart cards or other forms of physical devices with encrypted keys have been used in conjunction with logging in with a user name and password. These solutions typically require the use of additional hardware to read the contents of the physical device as in the case of a smartcard. Identification in currently implemented digital signature systems relies on the possession of the transaction party of a “private key” of an asymmetric private-public-key pair. Various schemes including certification and registration authorities are defined using the asymmetric keys under ANSI's X.509 standard. As these keys typically are kept on a desktop or mobile computer, however, they are not portable unless utilized in conjunction with a portable physical device. For the keys stored on the computer, encryption of the keys on the computer with the use of a password to unlock the keys for each transaction constitutes only a single security factor logon in that knowledge of the user name and password is all that is required of the user.

Multiple security methods have been combined for different purposes. An example is provided in U.S. Pat. No. 5,485,519, entitled “Enhanced Security for a Secure Token Code,” issued to Weiss, which discloses a method and apparatus for enhancing the security for a private key by combining a PIN or other secret code memorized by the user with a secure token code to generate a meaningless multi-bit sequence stored in the token. This particular method is viewed as too complex for many of the day-to-day transactions that require authentication of the identity of a party.

There is a need for a portable identification device carried by ordinary people (as consumers, employees or non-specialized professionals) that is usable with ordinary computers (such as desktop or notebook computers) that will not be usable if the device is lost or stolen.

### SUMMARY OF THE INVENTION

The instant invention solves this problem by providing (unencrypted or encrypted) random information stored on a truncated CD card (or other convenient device readable by currently popular computers, such as a USB memory key, or in storage for a portable processor such as a PDA or wireless telephone), a random portion of which is selected and concatenated with information known to the user of the device but not stored in the device (“personal code” such as a password) to form a “one-use” token. That token is compared to a token generated in parallel through the identical process from identical information associated with the user and held in a data base maintained by an authenticating entity (“authenticator”), which also designates the random selection of the random information on the storage device, for example, by a randomly selected size, offset and shift. If the tokens match exactly, the sender of the token is authenticated as the user based on the sender's knowledge of the user's personal code and possession of the unique random information held in the device assigned to the user, thereby employing two security factors.

The token is sent from the user's computer to a server running authentication software (the “Authentication Server”) that is either run by an authentication service provider (a “trusted third party”) on a wide area network such as a dedicated telecommunication channel or the Internet or by a network authenticator on a local area network. Particularly in the communications over open networks, it is useful to apply a known “one-way hash” (results from which it is mathematically infeasible to derive the input) algorithm such as MD5 or SHA-1 to the concatenation of the information selected from the storage device and the personal code to prevent misappropriation of the device information and the personal code.

The invention may be used in a variety of security applications. In one embodiment, it is used to authenticate the user and to provide one-use tokens to the user for authenticating the user to an authentication-seeking entity which submits the token to the authentication server to verify that the tokens are assigned to the user. In another embodiment, the invention may be used to generate tokens to authenticate particular versions of documents created by the user. In yet another embodiment, the invention may be used to authenticate the user to allow access to secure facilities.

### BRIEF DESCRIPTION OF THE DRAWINGS

FIG. 1 shows schematically the system and process of an implementation of the invention in which a transaction party seeks to authenticate the transaction counter-party.

FIG. 2 shows schematically the system and process of an implementation of the invention used to authenticate documents or other work product.

FIG. 3 shows schematically the system and process of an implementation of the invention used to control physical access to a restricted facility.

FIG. 4 shows the steps and data flow of authentication in a preferred embodiment of the invention.

FIG. 5 shows a simplified data layout for the preferred embodiment of the invention.

### DETAILED DESCRIPTION OF PREFERRED EMBODIMENTS

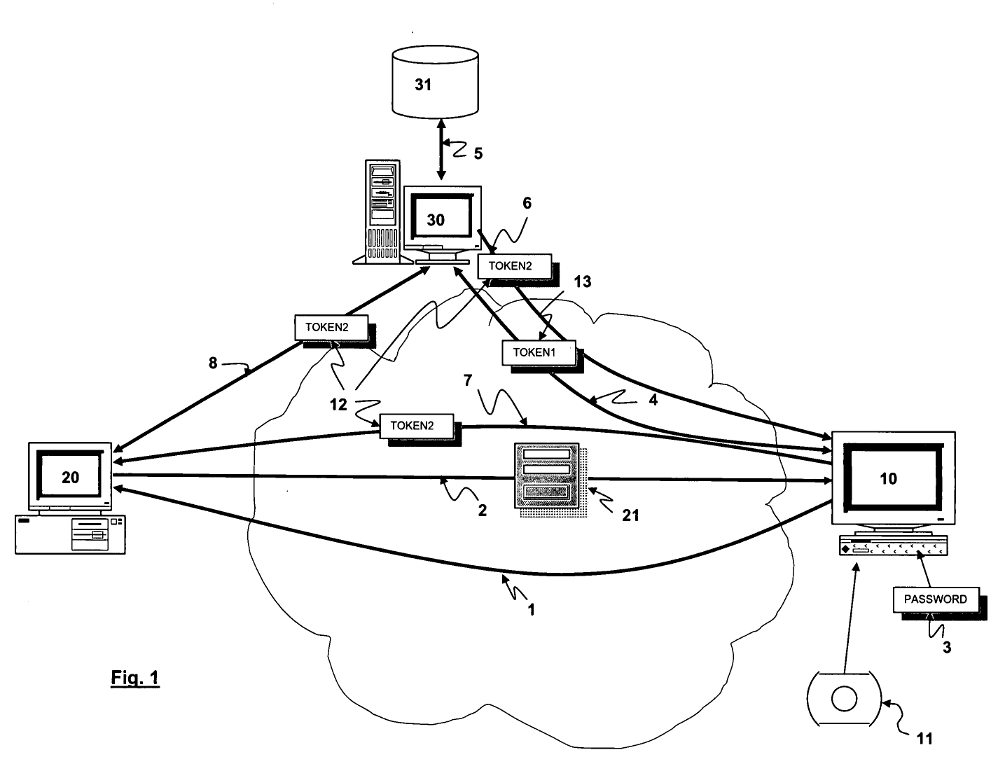

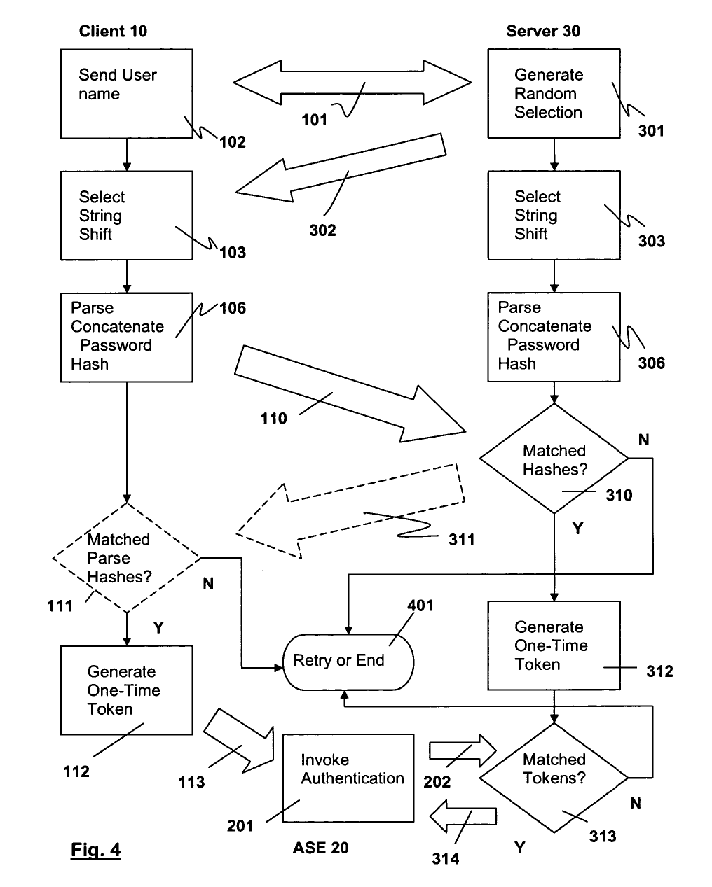

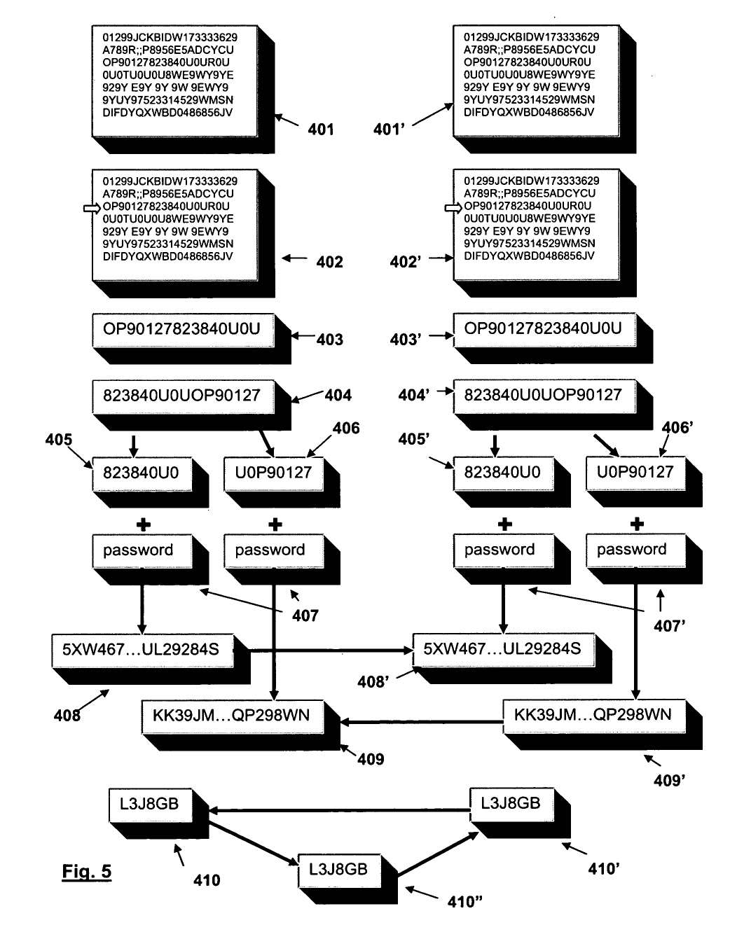

FIG. 1 shows an implementation of the invention involving a user at client computer 10 (which, without limitation, may be a desktop or notebook computer at home, at work or at a point-of-sale-or-service kiosk), an authentication-seeking entity or “ASE” computer 20 (which, without limitation, may be a desktop, workstation or institutional mainframe computer), and authentication server 30. In this implementation, the user contacts 1 ASE 20, which returns 2 a web page 21 The user enters a user name and password 3 (which may be any personal code known only to the user and to the secure server 30) and inserts into client 10 storage device 11 (these may be “CD-R cards”, which may be written using ordinary “CD burners” or a flash memory device, including USB memory keys). It is to be understood that client 10 may be a hand-held digital processor such as a personal digital assistant or a wireless telephone terminal for which storage device 11 may be integral or removable. The client 10 interacts 4 with the authentication server 30, which accesses 5 data base 31 according to the user name and the steps shown in FIGS. 4 and 5, as described below, creating at both client 10 and server 30 in effect a first one-use token 13 (which in the preferred embodiment is split and transmitted one in each direction). If the user is authenticated through matching of the token 13, that is, of a putative token 13 transmitted from one of the client 10 or server 30 with a token 13 stored at the server 30 or client 10, a second one-use token 12 is generated for transmission 7 to the ASE 20. (Shown here is generation by the server 30 and transmission 6 to client 10, possibly using session encryption; the token 12 may also be generated in parallel or be the same as token 13.) One-use token 12 may include time-restrictions and may be the same or part of the same one-use token as one-use token 13, or may be a digital certificate. ASE 20 interacts 8 with server 30, comparing token 12 received by ASE 20 from client 10 with the token on file for the user in data base 31 at server 30. If there is no match, there may be further prompting and termination of the transaction if the appropriate token is not transmitted. It is to be understood that communications between the various entities may be over the Internet or using private dedicated wire lines or wireless channels and may include encryption or some other form of obfuscation. In the preferred embodiment, the password 3 is never communicated between entities as cleartext, that is, unencrypted.

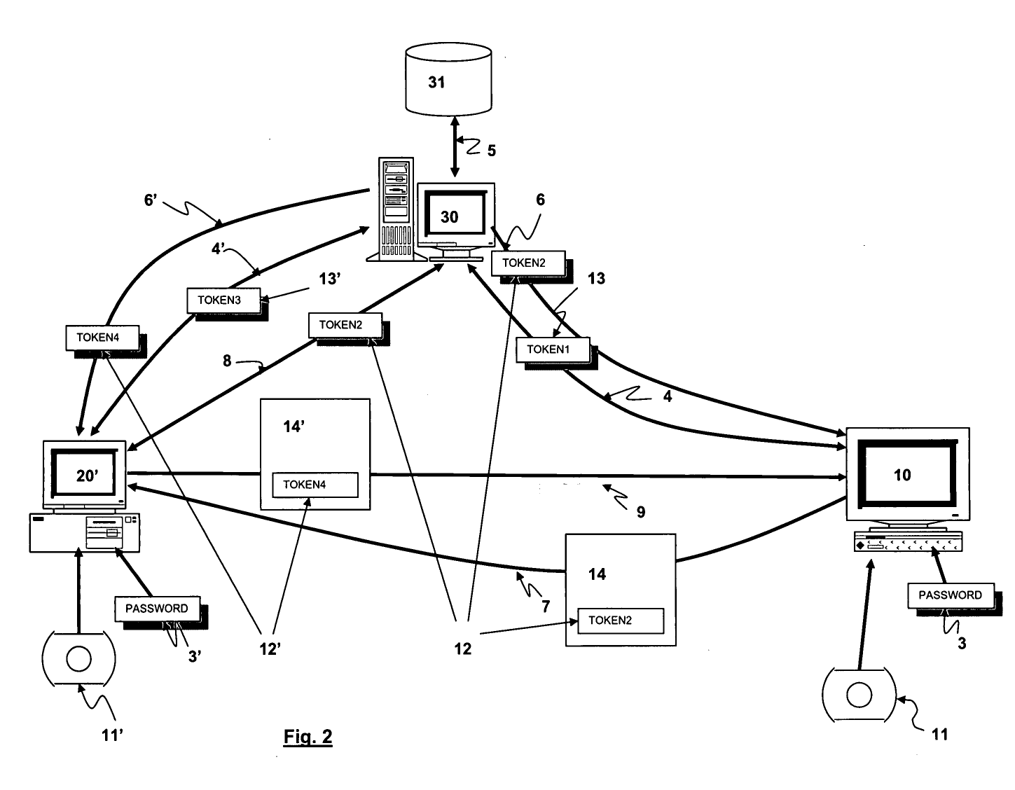

FIG. 2 shows an application of the invention in which authentication server 30 authenticates a document 14 (or other work product) created by the user at client computer 10 and a document 14′ created by another user at client computer 20′. When the user at client computer 10 applies thereto storage device 11 and provides password 3, client computer 10 interacts 4 with server 30 finding information on data base 31 corresponding to the user name to produce token 13 used to authenticate the user and token 12 used to authenticate document 14. When the second user at client computer 20′ applies thereto storage device 11′ and provides password 3′, client computer 20′ interacts 4′ with server 30 finding information on data base 31 corresponding to the user name to produce token 13′ used to authenticate the second user and token 12′ used to authenticate document 14′. If document 14 is sent 7 by the first user to the second user, its authenticity may be verified by the second user's computer 20′, acting as an ASE, by matching 8 token (or certificate) 12 included with document 14 with token 12 on file 31 with server 30.

Using this implementation, the one-use token or digital certificate, exemplified by tokens 12 and 12′, may serve as a signature associated with the transaction or documentation of the transaction. Records of the transaction with date-stamps may be kept by the authentication server 30 with little burden on the users.

The system and process may be integrated into desktop applications at client computers 10 and 20′ as plug-in modules or as separate client-side application programs. For example, transaction parties as users may negotiate a contract by exchanging “red-lined” revisions, and upon agreement (or a “milestone” in a “rolling contract” that continues to evolve), one party may invoke the authentication system and process, for example, by clicking a button in a toolbar or printing to the client-side authentication application. The client-side authentication application would prompt for insertion of the party's authentication key, that is, the information resident on the CD card (or other storage device) 11 and for the entry of the user's personal information 3. Once the key 11 is inserted and the user name and password 3 are entered, authentication of the user is conducted by authentication server 30 communicating with the client-side authentication application at computer 10. If authentication succeeds or has succeeded previously (through periodic background processing), the party's “signature” 12 is applied to the document 14; this may simply be a one-use token or a certificate or other key that can be matched to the user by the authentication server 30. In this application, each transaction party (and there may be more than two) may act as an ASE for the other transaction parties. Alternatively, there may be no ASE at all, but the authentication server 30 would be a registry for signing or authentication events established by the transmission to it directly (and matching) of the information generated using the CD-resident information and the personal information, with different possibilities for the authentication server's or ASE'S archiving of documents- or transaction-identification information, copies of signed documents, unique digital “hashes”, etc.

It should be understood that the authentication server 30 in each of the embodiments described above may be owned by the same legal entity that owns the ASE 20 and may be on the same local network, as may be the user terminal 10. Thus, the invention may be usefully applied to authentication of users on corporate intranets.

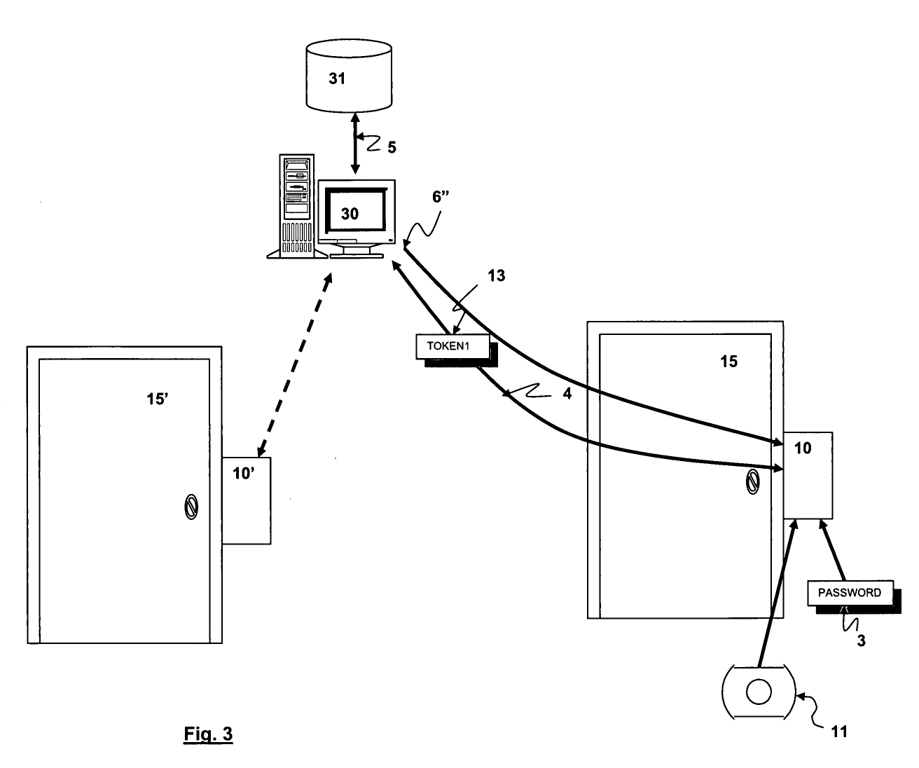

FIG. 3 shows an application of the invention to physical access where access through secure doors 15 and 15′ are respectively controlled by processors 10 and 10′. Thus, a user seeking to enter door 15 inserts the portable storage device key 11 to be processed by processor 10 and enters a user name and password 3. The processor 10 interacts 4 with security access server 30 with the parallel generation of a one-use token 13 at the client side based on the information held in the storage device key 11 and the password 3 and at the server side based on information in data base 31 corresponding to the username. A match of the token 13 triggers instruction 6″ to open door 15. User access to other restricted resources, such as restricted resources on a client computer, including access to a virtual private network or a financial network, to secure files, system administration, filter settings, or other restricted functionality (e.g., renting of a computer or use of a “Wi-Fi hotspot”), may be controlled analogously through the transmission of the server, upon token-matching, of a control signal or authorization information as appropriate to the resource application. Alternatively, where the possibility of having the client-generated token masquerade as the server-generated token is acceptably low, the tokens may be matched at the client and authorization of access to the resource granted locally.

It should be understood that in each of the embodiments described above, various security/authority levels may be assigned to different authentication keys or personal codes or combinations thereof and the tokens, certificates or keys generated therefrom. Added security through encryption of data messages may be used on a session basis through known protocols for communication over various media, including wireless.

A variety of known means may be used to initiate and conduct the authentication of the user at the client side, depending on the application. For example, in FIG. 1, the ASE 20 includes a web server that transmits information in the form of web page 21 to client 10. In this implementation client 10 applies a browser program to read web page 21 which in the example, requests authentication. To proceed, the user initiates the user authentication process between client 10 and authentication server 30. The initiation may be performed by a client-side application or by a browser plug-in. A browser plug-in may, for example, initiate the user authentication process upon insertion of CD card 11 into the CD drive of client computer 10. Upon authentication and the return (or designation or creation within client 10) of token 12, the user can input the token into the browser or a client-side application may automatically pass the tokens to the browser to return message 7 to ASE 20 Alternatively, the browser may pass the information on to a web authentication client via client-side scripting, which loads the plug-in and passes the appropriate authentication information.

In the example of FIG. 2 for authenticating documents, authentication client libraries may be provided in clients 10 and 10′ from which subroutines for performing authentication may be called by the word processing programs used for generating documents 14 and 14′. In some applications, access to an application on the client 10 may require prior and possibly periodic authentication of the user. In the example of FIG. 3 for physical access, dedicated processors 10 and 10′ may include specialized hardware or firmware to optimize authentication processing and storage devices 11 and 11′ may be magnetic cards, flash memories or other portable media, including active or reactive wireless devices.

Referring to FIG. 4, authentication begins at client 10 when the user enters a user name and password or PIN. In a desktop environment, this information may be collected by a desktop application and passed to an authentication library via the library application program interfaces. In a browser environment, the browser may perform a request for authentication or “challenge”, and then the user is prompted to provide an authentication sequence using the information stored on the user's storage device along with the user's personal information.

The authentication session proceeds in exchange 101 with client 10 opening a connection to the authentication server 30 and verifying its identity. The client version number is passed with other interface or “handshake” information. The server acknowledges that it can handle the request or declines the request. If the server declines the request, both sides close the connection and the authentication fails.

After negotiating the protocol version, client 10 sends the user identification (user name) in step 102. With this user identification, authentication server 30 looks up the user record in data base 31 to identify information stored in the data base and associated with that user, which should be identical to the information on the CD card 11 the user should have in the client-side CD-ROM drive or other physical storage device. In one embodiment each CD card 11 includes one megabyte of unique random information, each with a duplicate image in the data base 32. This is show respectively as information blocks 401 and 401′ in FIG. 5.

If a record is found and is valid, the server 30 acknowledges and returns information to the client 10 on where to look on the CD card 11 for the appropriate authentication key data. This is performed in step 301 by server 30 using a server-global random number generator to randomly generate a key offset (location of start of a key string to be selected), a key length (size), and a key shift (positions shifted in a rotation). These values are transmitted to client 10 in step 302.

Upon receiving the acknowledgement and key values, the client 10 reads the CD card 11 or other physical storage media and retrieves the data specified by the server 30. The data is retrieved beginning at the key offset, shown by the arrow in information block 402, pointing to the first character of the third row, “O”. In a preferred embodiment, a string is selected by reading from the CD card 11 until “key length” (of at least 512) bytes have been accumulated. This is depicted as the 16-character string 403, “OP90127823840UOU”. The string is shifted a “key shift” number of bytes, that is rotated a “key shift” number of bytes in order, as in a shift register, to produce a string of the same length. Depicted is a seven-character shift to produce 16-character string 404, “823840UOUOP90127”. These client 10 steps 103 are performed in parallel as steps 103′ by server 30 on what should be identical information associated with the user name in data base 31 to produce what should be an identical string, illustrated as 16-character string 404′, “823840U0UOP90127”.

In one embodiment, the data string resulting from steps 103 is parsed, split in half, as illustrated by strings 405 (“823840U0”) and 406 (“UOP90127”). The upper half is then concatenated with the user's password (illustrated by 407) and passed through a one-way hash algorithm to produce effectively a one-use token bound to the unique storage device 11 information and the password 3, but from which neither can be reproduced. (A variation of this embodiment would allow a selection from alternative one-way hash algorithms for a given session.) Using the SHA-1 algorithm, a first 160-bit key or token is produced as a message digest (hash result), represented by key or token 408 (“5XW467 . . . UL29284S). These client 10 steps 106 are performed in parallel as steps 106′ by server 30 to produce what should be an identical key or token represented by token 408′.

This first key or token is sent 110 by a client-side application to authentication server 30 for matching in step 310. Upon a match of the first key, as represented as a match of keys 408 and 408′, the process is repeated in reverse with the authentication server 30 creating a second one-use token or key 409′ by applying the SHA-1 algorithm to the lower half 406′ of the randomly selected and shifted information from the CD card image in data base 31 concatenated with the user's password 407′. (This process is optional; while enhancing the strength of the authentication, a single one-use token, such as represented in FIG. 1 by token 13, may be used.) The authentication server 30 sends 311 the second one-use 160-bit key back to the client 10 for matching 111. The client will have generated an identical key (represented by 409) and will attempt a match. If both sets of keys match, the user is authenticated and allowed to proceed with web-based use, granted access to restricted desktop software, or is given unique information such as a one-use token or a certificate for authentication to an ASE 20. In appropriate applications, the random information from the storage device 11 or its copy in data base 31 may be used to generate such unique information, including use of the authentication token 13, forwarded from the authentication server 30 to the client 10, or generated in parallel at both server 30 and client 10 according to a common algorithm applied to the random information associated with the user, optionally including other information such as the personal code or a time-stamp.

In one embodiment, as shown in FIG. 1, the one-use token 12 is a shorter authentication key or checksum, for example, six characters as shown as token 410 (“L3J8 GB”) in FIG. 5. This token may be generated by authentication server 30 (represented by 410′), for example by a random number generator, and transmitted to client 10 either as cleartext or using known encryption techniques, such as SSL, sent to ASE 20 and compared to the copy at server 30. Alternatively, referring to FIG. 4, token 410 may be generated by client 10 in step 112 in parallel with the generation of token 410′ by server 30 in step 312, and sent 113 to ASE 20. ASE 20 may invoke authentication 201 and send 202 token 401″ to server 30 for matching 313. If there is a match, server 30 returns 314 acknowledgement of authentication.

In one embodiment, once the user has been authenticated, the authentication server 30 will restart the authentication process at regular intervals. This may be performed as a background process in which the user is not required to re-enter the user name and password. However, if the user moves to another domain within the web server that would require a login or authentication, the user may be required to start the process from the beginning. If there is no match, for example, when the storage device 11 is removed from the client 10, the process aborts 401 (FIG. 4) after a predetermined number of re-tries.

If at any time during the process the connection is broken between the client 10 and the server 30, the client and server both assume that the authentication is a failure. The server may further respond to unusual terminations by locking the user account or blocking the client altogether. If the client fails a prescribed number of attempts, the server may lock out the user and not accept authentication requests for that user, either for a short period of time or until released by an operator. If the client fails a longer run of attempts, it may permanently lock out the user.

In the foregoing specification, the invention has been described with reference to specific embodiments thereof. It will, however, be evident that various modifications and changes may be made thereto without departing from the broader spirit and scope of the invention, including, without limitation the use of more or fewer randomizing steps, the use of more or fewer tokens, the use of more or fewer steps of encryption, processing bit-by-bit instead of byte-by-byte, and transmission over various media and in alternate directions. The authentication process disclosed herein may be advantageously used even if the storage of random information associated with the person authenticated is not portable, but situated in a desktop computer. To the extent of assurance that the storage (or the computer) is only accessible to the user through physical or other restriction, this may provide a security factor comparable to possession of the storage device. The embodiments disclosed herein are thus to be considered illustrative rather than restricting.

We claim:

1. A system for authentication of a party comprising:
an authentication server associating a unique set of information with said party, said unique set including at least a unique ordered set of information randomly generated; responsive to receipt of identifying information of said party to determine by random generation values of one or more prescribed parameters to define an ordered subset of said ordered set, to transmit said values, to generate a first token from said ordered subset, to compare said first token to a second token received in response to said transmission, and upon a match, to authenticate said party; and
a separate processor operated by said party adapted to read locally a storage medium containing a copy of said unique set of information associated by said server with said party, to transmit to said server said identifying information, to receive said values from said server, to apply said values to define an ordered subset of said copy, and to transmit said second token generated from said ordered subset of said copy.

2. The system of claim 1 wherein said first token includes personal code known to said party and stored and associated with said party at said server and said second token identically includes said personal code entered by said party at said separate processor.

3. The system of claim 1 wherein said server further comprises means for, upon said match, generating and storing a transaction token and transmitting to said processor said transaction token; said system further comprising an authentication-seeking entity adapted to receive from said processor said transaction token, to transmit said transaction token to said server, and to receive from said server authentication upon match by said server of said stored transaction token with said transmitted transaction token.

4. The system of claim 1 further comprising an authentication-seeking entity adapted to receive from said processor said second token, to transmit said second token to said server, and to receive from said server authentication upon match by said server of said first token.

5. An authentication server associating a unique set of information with a party to be authenticated, said unique set including at least a unique ordered set of information randomly generated; said server responsive to receipt of identifying information of said party to determine by random generation values of one or more prescribed parameters to define an ordered subset of said ordered set, to transmit said values, to generate a first token from said ordered subset, to compare said first token to a second token received in response to said transmission, and upon a match, to authenticate said party.

6. The authentication server of claim 5 wherein said first token includes personal code known to said party and stored and associated at said server with said party.

7. A processor operated by a party to be authenticated, said processor adapted to read locally a storage medium containing a copy of a unique set of information associated by a separate authentication server with said party, to transmit to said server information identifying said party, to receive from said server values of one or more prescribed parameters to define an ordered subset of said copy, and to transmit to said server a token generated from said ordered subset of said copy.

8. The processor of claim 7 wherein said token includes personal code known to said party and stored and associated with said party at said server, said processor further comprising means for receiving entry by said party of said personal code.

9. A computer program product for server-side authentication of a party, said computer program product residing on a computer-readable medium comprising instructions for causing a computer: to associate a unique set of information with a party to be authenticated, said unique set including at least a unique ordered set of information randomly generated; to receive identifying information of said party; to determine in response to such receipt by random generation values of one or more prescribed parameters to define an ordered subset of said ordered set; to transmit said values; to generate a first token from said ordered subset; to receive a second token; to compare said first token to a second token received in response to said transmission; and, upon a match, to authenticate said party.

10. The computer program product of claim 9 wherein said unique set of information associated with said party further comprises personal code known to said party and said instructions further comprise instructions to generate said first token from both said ordered subset and said personal code.

11. A computer program product for client-side authentication of a party, said computer program product residing on a computer-readable medium comprising instructions for causing a computer: to read locally a storage medium containing a copy of a unique set of information associated by a separate authentication server with said party; to transmit to said server information identifying said party; to receive from said server values of one or more prescribed parameters to define an ordered subset of said copy; to generate a token from said ordered subset of said copy; and to transmit to said server said token.

12. The computer program product of claim 11 further comprising instructions: to receive entry by said party of personal code stored and associated with said party at said server; and to generate said token from both said ordered subset and said entered personal information.

13. A process for authenticating a party comprising selection at a central location of a randomly selected portion of random information uniquely associated with said party, parallel selection at a party location separate from said central location an identical portion of a putatively identical copy of said information issued to and possessed by said party, and comparison at said central location of a first token uniquely generated from said randomly selected portion with a second token uniquely generated from said identically selected portion.

14. The process of claim 13 wherein said first token includes personal code known to said party and stored and associated with said party at said central location and said second token identically includes said personal code entered by said party at said separate location.

15. A process for authenticating a party comprising the steps of:
(a) accessing by said party through a client computer of an authentication server that has stored random information uniquely associated with said party, a copy of which was previously provided to said party and accessible at the client side;
(b) generating by said server or said client at least one random value for an authentication session of a parameter for selecting an ordered subset of said stored random information;
(c) transmitting by said server or client respectively to said client or server said generated value;
(d) applying by said client said generated value or values to select an ordered subset of said copy information;
(e) generating by said client from said ordered subset of copy information a client-side party-authenticating token;
(f) applying by said server of said generated value or values to select an ordered subset of said stored information;
(g) generating by said server from said ordered subset of stored information a server-side party-authenticating token;
(h) transmitting by said client to said server said client-side token or by said server to said client said server-side token; and
(i) comparing by said server said client-side token with said server-side token or by said client said server-side token with said client-side token.

16. The process of claim 15 wherein step (b) comprises the steps of generating random values for an offset, a length and a shift; and steps (e) and (g) each comprise the step of applying a specified one-way hashing algorithm to generate respectively said client-side and server-side party-authenticating tokens.

17. The process of claim 15 wherein a copy of personal code known to said party is stored and associated with said party at said server and wherein
step (e) further comprises the steps of (I) concatenating said ordered subset of copy information and said personal code entered by said party and (II) applying a specified one-way hashing algorithm to generate said client-side party-authenticating token; and
step (g) further comprises the steps of (I) concatenating said ordered subset of stored random information and said personal code copy and (II) applying said specified one-way hashing algorithm to generate said server-side party-authenticating token.

18. The process of claim 17 wherein step (b) comprises the steps of generating random values for an offset, a length and a shift.

19. The process of claim 18 wherein step (b) further comprises selection of a one-way hash algorithm.

20. The process of claim 15 wherein a copy of personal code known to said party is stored and associated with said party at said server and wherein
step (e) further comprises the steps of (I) dividing said ordered subset of copy information into first and second portions; (II) concatenating each of said first and second portions with said personal code entered by said party; (III) applying a specified one-way hashing algorithm to said concatenation of said first portion to generate said client-side party-authenticating token; and (IV) applying said specified one-way hashing algorithm to said concatenation of said second portion to generate a second client-side party-authenticating token;
step (g) further comprises the steps of (I) dividing said ordered subset of stored random information into first and second portions corresponding to said first and second portions of step (b); (II) concatenating each of said first and second portions of this step with said personal code copy; (III) applying said specified one-way hashing algorithm to said concatenation of said first portion to generate said server-side party-authenticating token; and (IV) applying said specified one-way hashing algorithm to said concatenation of said second portion to generate a second server-side party-authenticating token;
step (h) is performed by said client;
step (i) is performed by said server; and, wherein, if step (i) results in a match, said process further comprises the steps of
(j) transmitting by said server to said client said second server-side token; and
(k) comparing by said client of said server-side token with said client-side token.

21. The process of claim 20 wherein step (b) comprises the steps of generating random values for an offset, a length and a shift.

22. The process of claim 21 wherein step (b) further comprises selection of a one-way hash algorithm.

23. The process of claim 15 applied to authenticating said party to an authentication-seeking entity in a transaction wherein, if step (i) results in a match, said process further comprises the steps of
(j) generating by said server a transaction token;
(k) storing at said server a copy of said transaction token associated with said party;
(l) transmitting by said server to said client said transaction token;
(m) transmitting by said client to said authentication-seeking entity said transaction token received from said server;
(n) transmitting by said authentication-seeking entity to said server said transaction token received from said client;
(o) comparing by said server of said transaction token received from said authentication-seeking entity with said copy of said transaction token associated with said party.

24. The process of claim 15 applied to authenticating said party to an authentication-seeking entity in a transaction wherein, if step (i) results in a match, said process further comprises the steps of
(j) generating by said server a server-side transaction authentication token from information associated with said party and stored at said server;
(k) transmitting by said server to said client information to specify parallel generation by said client of a client-side transaction authentication token from corresponding information made available at said client;
(l) generating by said client said client-side transaction token from said corresponding information;
(m) transmitting by said client to said authentication-seeking entity said client-side transaction token;
(n) transmitting by said authentication-seeking entity to said server said client-side transaction token received from said client;
(o) comparing by said server of said client-side transaction token received from said authentication-seeking entity with said server-side transaction token associated with said party.

25. The process of claim 15 applied to authenticating work product that said party creates or modifies using said client computer wherein, if step (i) results in a match, said process further comprises the steps of
(j) generating by said server a work-product-authentication token;
(k) storing at said server a copy of said work-product-authentication token associated with said party;
(l) attaching to said work product said work-product-authentication token to create a data object stored and movable as authenticated work product;
(m) storing said authenticated work product;
(n) extracting from said authenticated work product a putative work-product authentication token; and
(o) comparing at said server said stored work-product-authentication token with said putative work-product-authentication token.

26. The process of claim 15 applied to authenticating work product that said party creates or modifies using said client computer wherein, if step (i) results in a match, said process further comprises the steps of
(j) generating by said server a server-side work-product-authentication token from information associated with said party and stored at said server;
(k) transmitting by said server to said client information to specify parallel generation by said client of a client-side work-product-authentication token from corresponding information made available at said client;
(l) generating by said client said client-side work-product-authentication token from said corresponding information;
(m) attaching to said work product said client-side work-product-authentication token to create a data object stored and movable as authenticated work product;
(n) storing said authenticated work product;
(o) extracting from said authenticated work product said client-side work-product authentication token; and
(p) comparing at said server said serve-side work-product-authentication token with said client-side work-product-authentication token.

27. The process of claim 15 applied to authenticating said party for access to a restricted resource wherein, if step (i) results in a match, said process further comprises the step of
(j) transmitting by said server authorization to permit said access.

28. The process of claim 15 applied to authenticating said party for access at said client to a restricted resource wherein
step (h) is performed by said server;
step (i) is performed by said client; and if step (i) results in a match, said process further comprises the step of
(j) permitting by said client of access to said resource.

29. The process of claim 15 applied to authenticating said party for continuing access to a restricted resource wherein said copy is normally separate from and inaccessible by said client except when connected through action of said party and steps (b) through (i) are repeated periodically until step (i) fails to result in a match a predetermined number of times.
